(19) United States
(12) Patent Application Publication
(10) Pub. No.: US 2002/0178208 A1
(43) Pub. Date: Nov. 28, 2002

(54) Priority inversion in computer system supporting multiple processes

(75) Inventors: Gordon Douglas Hutchison, Eastleigh (GB); Brian David Peacock, North Baddesley (GB); Martin John Trotter, Ampfield (GB)

Correspondence Address: Gregory M. Doudnikoff, IBM Corp, IP Law Dept T81/503, 3039 Cornwallis Road, PO Box 12195, Research Triangle Park, NC, 27709-2195, US

(73) Assignee: International Business Machines Corporation, Armonk, NY (US)

(21) Appl. No.: 10/155,300

(22) Filed: May 24, 2002

(30) Foreign Application Priority Data
May 24, 2001 (GB) 0112571.5

(51) Int. Cl. G06F 9/00

(52) U.S. Cl. 709/102; 709/103; 709/104

(57) ABSTRACT

The invention relates to a method of operating a computer system supporting multiple processes having potentially different priorities. The system provides a wait-notify mechanism, whereby a first process can be suspended pending notification from a second process. The mechanism is controlled via a predetermined resource which-must be-owned by the first process when suspension is initiated, and the second process at the time of notification. During the suspension of the first process, the priority of a process that acquires ownership of said predetermined resource is increased, typically to a level equal to that of the first process. This ensures that the first process does not wait an unduly long time to be notified for resumption.

### FIELD OF THE INVENTION

The present invention relates generally to a method of operating a computer system supporting multiple processes having potentially different priorities.

### BACKGROUND OF THE INVENTION

In concurrent systems, priority inversion is a well-known problem that can lead to total system failure. An example of the problem of priority inversion happened with the Mars pathfinder probe. The Mars Pathfinder mission was widely proclaimed as “flawless” in the early days after its Jul. 4, 1997 landing on the Martian surface. Successes included its unconventional “landing”—bouncing onto the Martian surface surrounded by airbags, deploying the Sojourner rover, and gathering and transmitting voluminous data back to Earth, including the panoramic pictures that were so popular on the Web. But a few days into the mission, not long after Pathfinder started gathering meteorological data, the spacecraft began experiencing total system resets, each resulting in losses of data. The press reported these failures in terms such as “software glitches” and “the computer was trying to do too many things at once”.

In fact, the reason for this problem only later became apparent. Thus Pathfinder contained an “information bus”, effectively a shared memory area used for passing information between different components of the spacecraft. A bus management task ran frequently with high priority to move certain kinds of data in and out of the information bus. Access to the bus was synchronised with mutual exclusion locks (mutexes).

The meteorological data gathering task ran as an infrequent, low priority thread, and used the information bus to publish its data. When publishing its data, it would acquire a mutex, do writes to the bus, and release the mutex. If an interrupt caused the information bus thread to be scheduled while this mutex was held, and if the information bus thread then attempted to acquire this same mutex in order to retrieve published data, this would cause it to block on the mutex, waiting until the meteorological thread released the mutex before it could continue. The spacecraft also contained a communications task that ran with medium priority.

Most of the time this combination worked fine. However, very infrequently it was possible for an interrupt to occur that caused the (medium priority) communications task to be scheduled during the short interval while the (high priority) information bus thread was blocked waiting for the (low priority) meteorological data thread. In this case, the long-running communications task, having higher priority than the meteorological task, would prevent it from running, consequently preventing the blocked information bus task from running. After some time had passed, a watchdog timer would go off, notice that the data bus task had not been executed for some time, conclude that something had gone drastically wrong, and initiate a total system reset.

The scenario is a classic case of priority inversion, whereby a higher priority thread may end up waiting for a lower priority thread that currently owns some shared resource, and this lower priority thread may in turn be interrupted by a (slightly) higher priority thread. Note that real-time systems are particularly vulnerable to priority inversion, in that they typically rely upon thread priorities to ensure that tasks complete within a specified time.

One known solution to priority inversion is priority inheritance, whereby the owner of a shared resource has its priority set to the priority of the highest priority thread waiting to access that resource, and priority ceilings, whereby by gaining ownership of a resource automatically boosts the priority of the owning thread priority to some ceiling value. These solutions are well known and implemented with respect to operating system mutexes, which are the usual mechanism for synchronisation on shared resources (one example being the AIX operating system from IBM Corporation). In fact, in the Mars Pathfinder situation described above, priority inheritance was actually available in the thread package of the Mars Pathfinder but had been turned off ‘to boost performance’; the problem was eventually resolved by instructing it to be turned on again.

If we now consider the Java programming environment (Java is a trademark of Sun Microsystems Inc), Java programs are generally run on a virtual machine, rather than directly on hardware. Thus a Java program is typically compiled into byte-code form, and then interpreted by the Java virtual machine (VM) into hardware commands for the platform on which the Java VM is executing. The Java environment is further described in many books, for example “Exploring Java” by Niemeyer and Peck, O'Reilly & Associates, 1996, USA, and “The Java Virtual Machine Specification” by Lindholm and Yellin, Addison-Wedley, 1997, USA.

In the Java language, mutually exclusive access to shared resources is achieved by means of synchronisation. One of the advantages of the Java language is that this synchronisation is relatively simple for the end-programmer; there is no need at the application level to specifically code lock and unlock operations.

Java VM implementations of synchronisation are generally based on the concept of monitors which can be associated with objects. A monitor can be used for example to exclusively lock a piece of code in an object associated with that monitor, so that only the thread that holds the lock for that object can run that piece of code—other threads will queue waiting for the lock to become free. The monitor can be used to control access to an object representing either a critical section of code or a resource.

Locking in Java is always at the object-level and is achieved by the application applying a “synchronized” statement to those code segments that must run atomically. The statement can be applied either to a whole method, or to a particular block of code within a method. In the former case, when a thread in a first object invokes a synchronised method in a second object, then the thread obtains a lock on that second object. The alternative is to include a synchronised block of code within the method that allows the lock to be held by taking ownership of the lock of an arbitrary object, which is specified in the synchronised command.

The monitor structure in Java can also be used as a communication mechanism between separate threads of execution. This is achieved by a first thread including a “wait” command within synchronised code. This suspends execution of this first thread, and effectively allows another thread to obtain the lock controlling access to this synchronised code. Corresponding to the “wait” command is a “notify” command in synchronised code controlled by the same object lock. On execution of this “notify” command by a second thread, the first thread is resumed, although it will have to wait for access to the lock until this is released by the second thread. Thus when used for this purpose a thread may wait on an object (or event) and another thread can notify the waiter.

The “notify” command actually comes in two flavours: a “notify-all”, whereby all the threads waiting on the object are notified, and a simple “notify”, whereby only one (arbitrary) waiting thread is notified.

As the Java environment increasingly moves into the embedded and the hard/soft real time application space (for which, incidentally, it was originally designed), careful consideration must be made to make the Java concurrency primitives take account of the priority inheritance problem. As described above, Java synchronisation is based on monitors, and as these in turn will be normally be implemented using for example mutexes and condition variables from the underlying operating system. Thus the process for handling contention for monitor entry (i.e. acquiring a lock) will generally inherit the priority inheritance and/or ceiling scheme of the underlying operating system.

However, this is only a partial solution, since in Java, inter-thread synchronisation is frequently done using wait/notify, which is not directly controlled by an underlying mutex. Thus a very high priority thread may be waiting to be notified on a monitor that is currently owned by a low priority thread, which is CPU starved or de-scheduled. The low priority thread is therefore unable to progress and send a resulting notify to the high priority thread. Consequently the high priority threat is effectively stalled; as the high priority thread is not waiting on any underlying mutex, there is no operating system facility to assist.

### SUMMARY OF THE INVENTION

Accordingly, the present invention provides a method of operating a computer system supporting multiple processes having potentially different priorities, said method comprising the steps of: suspending a first process, pending notification from a second process, wherein said suspending occurs whilst the first process owns a predetermined resource of the computer system subject to mutually exclusive access, and said notification occurs whilst the second process owns said predetermined resource; and during the suspension of the first process, increasing the priority of a process that acquires ownership of said predetermined resource.

Thus the invention serves to provide a form of priority inheritance for raising the priority of the acquiring process. In the preferred embodiment, the priority of the acquiring process is increased to the level of the first process, assuming that the latter started with a higher priority than the former. On the other hand, if the acquiring process already has a priority equal to or higher than the first process, then no such increase is appropriate, and the acquiring process retains its original priority. Note that a variety of approaches could be used to determine the boosted priority level; for example, the acquiring process may be boosted only part of the way up to the level of the first process, and/or a priority ceiling may be imposed, representing a maximum possible boosted priority level for the acquiring thread. Other possibilities may also be known from prior art priority inheritance schemes.

The process that acquires ownership of the predetermined resource may be either the second process (i.e. the one that will do the notification), or a separate process acquiring the resource for some other purpose. In the former case, speeding up the second process (by increasing its priority) will directly result in a quicker notification; in the latter case, speeding up the separate process will allow earlier completion of its tasks. This in turn will make the resource available (or at least available sooner) to the second process when it does try to acquire it to notify the first process.

It will be appreciated that there may be zero, one, or multiple intervening processes that temporarily acquire ownership of the predetermined resource in-between the suspension of the first process (which results in release of the predetermined resource by the first process) and the subsequent notification by the second process. One or more of these intervening processes may themselves go into suspension, pending notification. Preferably in this case the priority of a subsequently acquiring process is then increased in accordance with the highest priority level of any suspended process (which may be the first process or one of the intervening processes).

In the preferred embodiment, the priority of the acquiring process is increased only for the time that it retains ownership of the predetermined resource; it returns to its original value after it releases ownership of the predetermined resource. This is the case even where the acquiring process is the second process, i.e. the process that performs the notification. Thus the increased priority is enjoyed not only until the notification is performed, but beyond this until the predetermined resource is released. This is important because in the preferred embodiment, the suspended first process cannot actually resume processing until it reacquires ownership of the predetermined resource.

The preferred embodiment also provides a queue of processes waiting to acquire ownership of the predetermined resource. The process that currently has ownership of the predetermined resource has its priority level increased to the highest level of any process in the queue. This corresponds essentially to the known priority inheritance approach of the prior art in a mutex environment. Note that this priority inheritance is only effective at times of contention, when there is already an owner of the predetermined resource, and a new process tries (unsuccessfully) to acquire the resource. The new process then gets added instead onto the queue, and the priority of the owning process adjusted if necessary. In fact, while one particular process owns the resource, there may be multiple other processes added onto the queue, with the priority of the owning resource being adjusted accordingly each time. On the other hand, the wait-notify priority inheritance disclosed herein does not require contention, but potentially applies whenever the resource is acquired (even if this is uncontended), providing that there are one or more suspended processes.

Preferably the prior art mutex priority inheritance in the case of contention is integrated with the wait-notify priority inheritance disclosed herein, so that the priority of the process that currently has ownership of said predetermined resource (or successfully acquires it) is increased to the highest level of any suspended process or any process in the queue. This is the most effective strategy for minimising the delay of any suspended or queuing process.

In the preferred embodiment, each of said processed comprises a thread, and the predetermined resource comprises a monitor. However, it will be appreciated that any suitable system facilities could be utilised. For example, a process could be any type of strand of concurrent execution (irrespective of whether the computer system provides true concurrency, such as a multiprocessor system, or just simulates it, for example by time-slicing).

The invention further provides a computer system supporting multiple processes having potentially different priorities, said system including: means for suspending a first process, pending notification from a second process, wherein said suspending occurs whilst the first process owns a predetermined resource of the computer system subject to mutually exclusive access, and said notification occurs whilst the second process owns said predetermined resource; and means for increasing the priority of a process that acquires ownership of said predetermined resource during the suspension of the first process.

It will be appreciated that such a computer system need not be implemented as a conventional computer, but could represent an embedded processing system in a very wide range of potentially intelligent devices, from telephone to aeroplane, and from microwave to automobile (and of course interplanetary spacecraft).

The invention further provides a computer program product comprising instructions encoded on a computer readable medium for causing a computer to perform the methods described above. A suitable computer readable medium may be a DVD or computer disk, or the instructions may be encoded in a signal transmitted over a network from a server.

It will be appreciated that the computer system and program product of the invention will generally benefit from the same preferred features as the method of the invention.

### BRIEF DESCRIPTION OF THE DRAWINGS

A preferred embodiment of the invention will now be described in detail by way of example only with reference to the following drawings:

FIG. 1 is a schematic drawing of a computer system supporting a Java virtual machine (VM);

FIG. 2 is a schematic diagram showing the Java VM in more detail;

FIG. 3 is a flowchart showing two threads obtaining synchronised access to a monitor;

FIG. 4 is a flowchart showing two threads using a wait-notify construction;

FIG. 5 is a diagram showing the structure of a monitor in more details; and

FIG. 6 is a flowchart illustrating the priority boost mechanism.

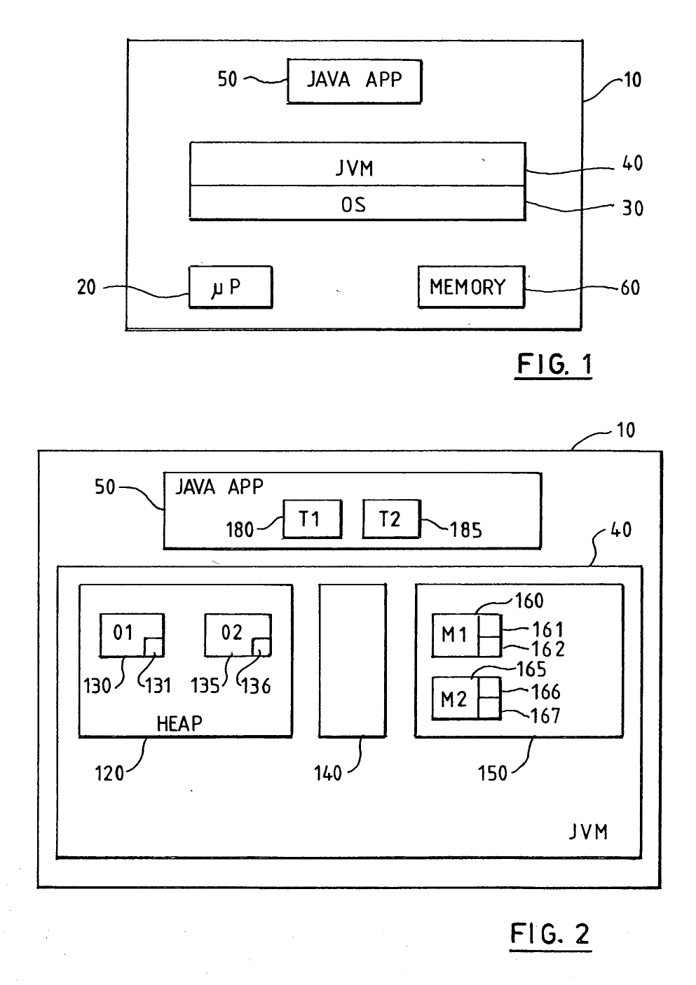

FIG. 1 illustrates a computer system 10 including a (micro)processor 20 which is used to run software loaded into memory 60. The software can be loaded into the memory by various means (not shown), for example from a removable storage device such as a floppy disc or CD ROM, or over a network such as a local area network (LAN) or telephone/modem (wired or wireless) connection, typically via a hard disk drive (also not shown). Computer system 10 runs an operating system (OS) 30, on top of which is provided a Java virtual machine (VM) 40. The Java VM 40 looks like an application to the (native) OS 30, but in fact functions itself as a virtual operating system, supporting Java application 50.

It will be appreciated that computer system 10 can be a standard personal computer or workstation, minicomputer, mainframe, palmtop, or any other suitable computing device, and will typically include many other components (not shown) such as display screen, keyboard, sound card, network adapter card, etc. which are not directly relevant to an understanding of the present invention. Note that computer system 10 may also be an embedded system, such as a set top box, or any other hardware device including a processor 20 and control software 30, 40, and indeed, the advantages of the present invention may be of particular benefit in this domain.

FIG. 2 shows the Java VM 40 and Java application 50 in more detail. Thus Java application 50 includes multiple threads, T1 180 and T2 185. These threads are run in parallel by Java VM 40, thereby giving rise to possible contention for resources between T1 and T2. As mentioned previously, such contention can even arise when Java application 50 is single-threaded, because some of the Java VM which runs Java application 50 is itself written in Java and contains multiple threads.

Looking now at the Java VM 40, this includes a heap 120 which is used for storing multiple objects, O1 130 and O2 135. There is also a pool 150 of monitors, including monitors M1 160 and M2 165. Within each monitor are data fields 161, 162, and 166, 167 respectively whose purpose will be described in more detail below. Hash table 140 can be used to ascertain the monitor corresponding to a particular object id. It will be appreciated that the monitors are typically based on an underlying implementation provided by the OS 30.

It will be appreciated of course that FIG. 2 is simplified, and essentially shows only those components pertinent to an understanding of the present invention. Thus for example the heap may contain thousands of Java objects in order to run Java application 50, and the Java VM 40 contains many other components (not shown) such as class loaders, JIT compiler, stack etc.

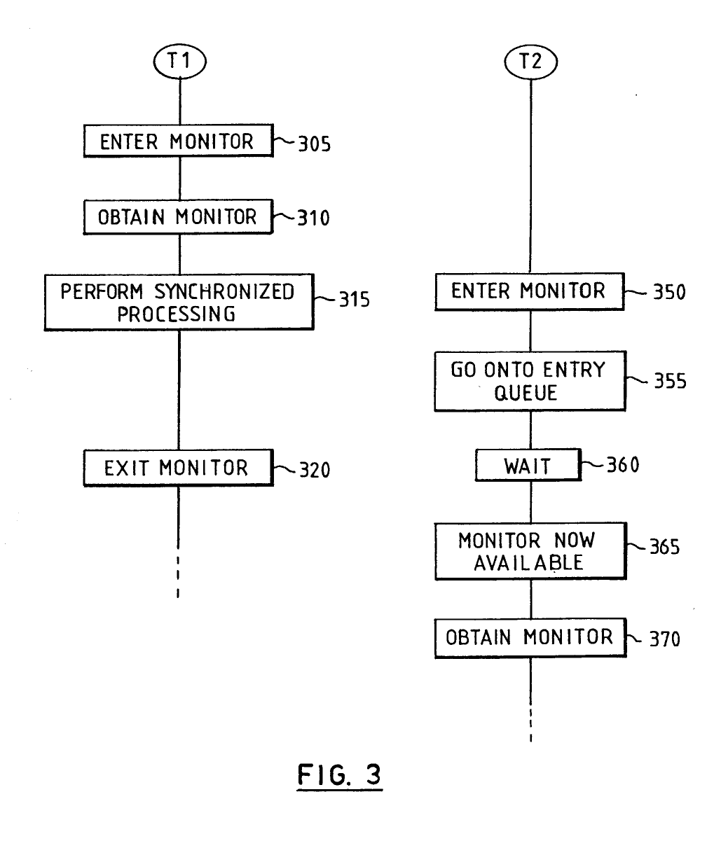

FIG. 3 is a flowchart showing standard monitor operation for a synchronised statement in Java. This statement is used to control contention between two threads T1, T2 for a resource for which concurrent access is not permitted. Thus the synchronised code utilises the monitor to act a mutex, so that only a single thread can access the resource at a time.

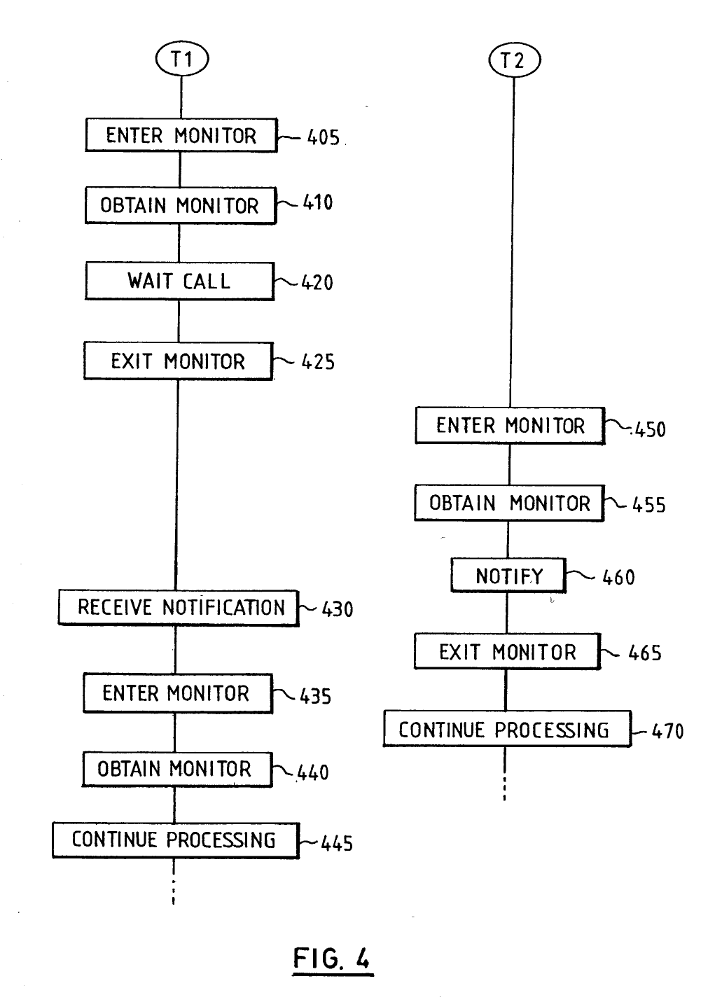

The system actually supports four different operations on a monitor: Enter, Exit, Wait and Notify. Enter and Exit are used to determine ownership of the underlying mutex associated with the monitor. As previously mentioned, they are not coded directly into the application, but rather utilised by the Java VM code to implement synchronisation.Wait and Notify are used to perform the Wait-Notify construct in Java and will be discussed below in relation to FIG. 4. Note that the Java language further supports a Notify-All operation as described above; this can be regarded as a special case of Notify.

Looking now at the method of FIG. 3, T1 initially encounters the synchronised method or block of code, and tries to obtain the monitor associated with that code. This involves issuing an enter command on the monitor, step 305. Since the monitor is assumed to be currently available, this is followed by T1 successfully obtaining the monitor, step 310. Thread T1 now performs the relevant synchronised code, step 315, and can use whatever resource is protected by the monitor. Meanwhile, thread T2 also encounters a synchronised method of block of code associated with the same monitor. However, when it tries to enter the monitor, step 350, it fails to obtain the monitor, since it is already owned by thread T1. Instead, in step 355 it is placed on an entry queue associated with that monitor (shown schematically as block 161 for M1 and 166 for M2 in FIG. 2), and has to wait in this queue, step 360, until T1 releases the monitor.

Subsequently thread T1 finishes its synchronised processing, and so exits the monitor, step 320. At this point, it is detected that the entry queue for this monitor contains T2, and so thread T2 is informed that the monitor has been released, step 365. Accordingly, thread T2 is now able to resume and enter the monitor successfully, thereby obtaining ownership of the monitor, step 370. T2 then proceeds to perform its own synchronised processing, included access of the protected resource (not shown in FIG. 2).

A priority inversion problem as described above could potentially occur in the situation shown in FIG. 3, if T1 is low priority thread, and T2 a high priority thread. Thus at step 360, T2, the high priority thread, is forced to wait for T1, the low priority thread, to finish processing of the synchronised code, step 315. However, it may be that in performing this processing, T1 is held up by another thread T3 of medium priority (for example the scheduler assigns most processing time to T3 rather than T1). Unfortunately, this delay affects not only T1, the low priority thread, but also T2 the high priority thread, which cannot proceed until T1 releases the monitor, step 320.

As explained above, the above priority inversion problem has been recognised and addressed in the prior art by priority inheritance (or variations thereof). In this known approach, if a thread (T2) is waiting to obtain a monitor (operating as a mutex), then the (high) priority level of thread T2 can be associated with the mutex. This priority is then transferred to the process that currently owns the mutex (in this case T1). Thus T1 essentially receives a temporary priority boost, to allow it to finish its operations with the mutex. Once these operations have been completed, T1 releases the mutex, and drops back down to its original (lower) priority. It will be appreciated that this approach is effective at overcoming the priority inversion problem described above, since T1 in its boosted state will take precedence over medium priority thread T3, thereby allowing T1 to quickly release the mutex, and T2 to continue processing.

As previously indicated, most Java VM implementations use an operating system mutex to control monitor access and ownership. In addition, most operating systems provide some form of mutex priority inheritance mechanism as described above, which is then passed through effectively automatically to operations to acquire ownership of the Java monitor.

FIG. 4 illustrates a somewhat different form of synchronisation in Java, whereby a monitor is not used as a mutex to control access to a resource, but rather as a mechanism to control the relative timing of two threads T1 and T2. As shown in FIG. 4, T1 first enters the monitor (step 405), which is assumed to be available, and so successfully obtains ownership of the monitor (step 410). Thread T1 now issues a wait call (step 420). This has the effect of suspending T1, and placing T1 on a wait queue for the monitor (shown schematically as block 162, 167 in M1 and M2 respectively in FIG. 2). Thread T1 now exits the monitor (step 425).

A second thread T2 now comes along and enters the monitor (step 450). Since the monitor has been released by T1, T2 can successfully obtain ownership of the monitor (step 455). Thread T2 now issues a notify command (step 460), the purpose of which is to resume the waiting thread T1. Having issued the notify command, thread T2 now exits the monitor (step 465), and continues with other processing (step 470). Meanwhile, thread T1 receives the notification (step 430) from T2, and tries to enter the monitor (step 435). Assuming that T2 has by now exited the monitor, T1 will then successfully obtain the monitor (step 440) and can then continue processing (step 445).

It will be appreciated that the events shown in FIG. 4 represent a relatively simple case, with only two threads involved, but more complicated scenarios are possible. For example a third thread may acquire the monitor after it is initially released by thread T1 at step 425, for purposes unrelated to the synchronisation of T1 (e.g. to ensure exclusive access to a particular resource associated with the monitor). In this case T2 will not be able to successfully obtain the monitor (step 455) until it is released by the third thread. In other words, T2 will have to queue to enter the monitor, as depicted in FIG. 3.

Another possibility is that this third thread suspends itself, like T1, and that T2 then issues a notify-all command. In this case both T1 and the third thread will receive notification from T2 (step 430), but only one of them will be able to successfully obtain ownership of the monitor (step 440)—the other will have to queue to enter the monitor, again as depicted in FIG. 3.

It will also be appreciated that some of the processing shown in FIG. 4 occurs transparently to the thread at the application level. Thus at an application level, the wait call of T1 (step 420) is followed by the notify call from T2 (step 460), and the resumed processing of T1 at step 445. In other words, the application is unaware that in the meantime it has actually released the monitor, to allow T2 to obtain it, and then subsequently reacquired it (potentially following a delay for contention as suggested above if a third thread intervenes); rather these operations are all performed by the Java VM, effectively under the covers.

Now a priority inversion problem is also possible in connection with FIG. 4. This would arise if T1 is a high priority thread and T2 is a low priority thread, whose processing gets delayed by a third thread of intermediate priority. Consequently it might be much longer than expected before T1 is notified and reawakened by T2; certainly the timing would be variable and unpredictable depending on what other threads were in progress.

Note that the priority inheritance mechanism provided by the operating system mutex underlying Java monitors, as discussed in relation to FIG. 3, does not help here. The reason for this is that the wait-notify construct is not used to provide mutually exclusive access to a resource (i.e. mutex functionality); indeed, the monitor is actually released in between the wait and the notify (between step 425 and step 450), whereby it is freely available for other threads.

It is normally possible to overcome this priority inversion problem by better application design, in particular by focussing on the priority levels assigned to different threads. Indeed the same is true of pretty much all priority inversion problems. Nevertheless, practical experience shows that applications in real-life are not always perfectly designed (as per the Mars Pathfinder system described earlier), and therefore it is desirable for the operating system itself to support some form of solution.

Thus in accordance with the present invention, priority inheritance is supported not only from the ‘entry set’ of the Java monitor to the current owner but also from the ‘wait set’. The terminology here is that the entry set represents the queue of threads waiting to enter the monitor, as discussed in relation to FIG. 3, whilst the wait set represents those threads which are waiting to be reawakened by a notify call, as discussed in relation to FIG. 4.

A key point is that the wait set and entry set are not implemented using the same operating system constructs; the former is achieved by a mutex lock queue, the latter typically by a condition variable wait set as discussed in more detail below, which in operating system terms are essentially unrelated. Consequently, whilst prior art systems have implicitly (via the operating system) provided priority inheritance for the entry set, they have not provided, nor indeed even contemplated, any such mechanism for the wait set.

To understand how priority inheritance operates with respect to the wait set, it will be appreciated that in order to progress the waiting thread (assumed to be high priority), it must be notified, and the thread that notifies it (assumed to have a lower priority) must own the monitor at the time of notification. There are two main scenarios to consider:

(1) The current owner of the monitor is the thread that will (eventually) notify the high priority waiting thread. In this case we wish to boost the priority of the owning thread, not only until the monitor signals the high priority thread (step 460 in FIG. 4) but also from that point until it exits the monitor (step 465), since only then can the suspended thread actually reacquire the monitor (step 435). Note that once the notifying thread has exited the monitor (step 465), then the known mutex priority inheritance mechanism described in relation to FIG. 3 will ensure that the reawakened high priority thread should obtain prompt access to the monitor, even if it has to temporarily go into the entry set for the monitor (at step 435).

(2) The current owner of the monitor is not the thread that will notify the high-priority waiting thread. In this case the priority of the monitor owner is still promoted. Even although this thread will not itself notify the waiting thread, any thread that would notify the waiting thread must wait until the current owner has exited the monitor. Thus the current owner is still in a position to cause priority inversion across the wait-notify chain. Note in this context that once the notifying thread tries to enter the monitor (and hence goes onto the entry set), then known priority inheritance associated with the monitor mutex will also operate. However, this will only be effective if the notifying thread is of high priority; if instead it is low priority, then the current owner thread will not be boosted, prolonging the suspension of the waiting thread.

It will be appreciated of course that there is a third possibility, namely that there is no current owner of the monitor. In this situation, no priority boost is applied, but rather the system waits until the monitor does acquire an owner, at which point one of the two above cases will apply.

As previously indicated, the underlying construct used for Java wait-notification is often some form of condition variable. For example, with the AIX operating system, the underlying process of waiting is performed by using a “pthread_cond_wait” function. From the point of view of the calling thread, it is first necessary to acquire a mutex associated with the condition variable. This mutex plus the condition variable itself are then passed as arguments to the above call, which atomically unlocks the mutex and then ‘waits’ on the condition.

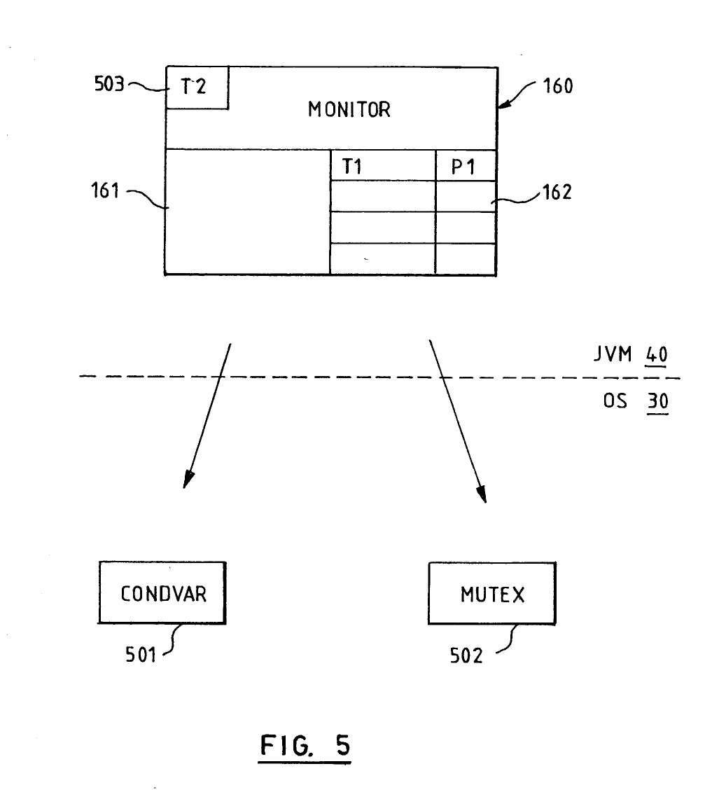

FIG. 5 illustrates in more detail the Java VM 40 implementation of a monitor 160 in a preferred embodiment of the invention. Associated with monitor, but provided by the underlying operating system 30 are mutex 502 and condition variable 501. The monitor 160 itself includes a field 503 that identifies the thread that currently owns the monitor—in this case T2, which in turn must own mutex 502. The monitor further contains two queues as previously discussed, an entry queue 161 of threads waiting to enter the monitor (currently assumed to be empty), and a wait queue 162 of threads waiting to be notified so that they can resume processing. In general these two queues will have similar structure, although in FIG. 5, for simplicity, only the wait queue is shown in detail. The wait queue can be seen to contain a single entry for thread T1, plus the priority level P1 of thread T1 (it will be appreciated that this does not necessarily need to be stored on the queue itself, since it is separately available from general thread information).

To understand a possible sequence of events that might lead to the configuration of FIG. 5, thread T1 initially enters monitor 160, acquiring mutex 502 and being written into field 503. Thread T1 then issues a “wait” command, which causes the monitor to set condition variable 501 using mutex 502. T1 is then placed on the wait queue 162, and exits the monitor, with mutex 502 being released, and field 503 nulled. Finally, thread T2 arrives to enter the monitor, resulting in the state shown in FIG. 5. Note that thread T2 could now issue a notify call to T1, passing the mutex 502 (which T2 now owns) to the condition variable 501.

As previously indicated, in the configuration shown in FIG. 5, the priority of thread T2 is boosted to the level of P1 (assumed to be higher than the original level of T2) in accordance with the present invention for as long as T2 owns monitor 160. This ensures that T2 notifies T1 as quickly as possible, or exits monitor 160 as quickly as possible to allow access by another thread (which may be the notification thread). After T2 exits monitor 160, then its priority level is reduced to its original value. Since T2 must exit the monitor in order for T1 to reacquire it following notification, it can be guaranteed that there will be no ‘leakage’ of priority boost.

It will be appreciated that the arrangement shown in FIG. 5 is schematic, and various modifications can be made. For example, the wait queue and/or the entry queue for the monitor may be maintained by the operating system 30 itself, in association with mutex 502 and condition variable 501 respectively. Note however that whilst this allows the mutex to provide its own priority inheritance mechanism, as discussed above, this is not possible or appropriate for condition variable 501. This is because the wait queue itself lists only the waiting threads, rather than any thread which might possibly have its priority boosted. In contrast, monitor 160 not only maintains a list of waiting threads, but may also be further acquired by another thread, either to perform the notification, or for some other synchronised operation.

Another possible modification is that whilst logically there is a mutex 502 and condition variable 501 for each monitor 160, this does not necessarily indicate the underlying implementation. For example, it is possible that the operating system only provides a single condition variable per thread, since a thread can only be waiting on one condition at a time. In such an approach, the condition variable 501 is only associated with monitor 160 for as long as the relevant thread is in the wait queue of monitor 160.

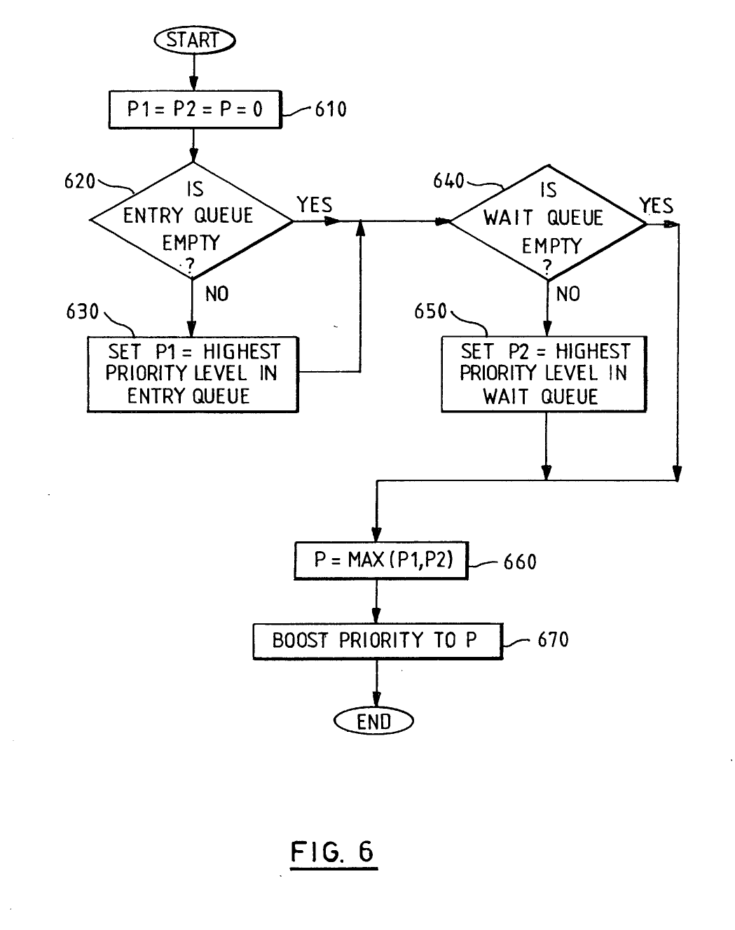

Although FIG. 5 shows only a single monitor in the wait queue, and an empty entry queue, other combinations are possible. FIG. 6 provides a flow chart illustrating the logical steps performed for determining priority boost in the general case. The method starts at step 610 where control variables P, P1, and P2 are initialised to zero. The method then proceeds to step 620 where a test is performed to determine if the entry queue 161 is empty; if not the variable P1 is set to the highest priority level of any thread in the entry queue, step 630. The method then investigates to see if the wait queue 162 is empty, step 640, and if not, the variable P2 is set to the highest priority level of any thread in the wait queue, step 650. Next, the variable P is set to the highest of P1, P2 (in terms of priority level), step 660, and finally the priority of the thread that currently owns the monitor is boosted to value P, step 670, for as long as it retains ownership of monitor 160. The degree of boosting may be subject to some ceiling value C, (i.e. P=min(C, P). In addition, boosting will not occur at all if the value of P is zero (both queues empty), or if the value of P is no greater than the current priority level of the thread that owns the monitor.

The processing of FIG. 6 will typically be performed whenever a thread attempts to enter a monitor, irrespective of whether the attempt is successful or unsuccessful. In the former case, it is the thread that is entering the monitor (and acquiring it) whose priority will be boosted at step 670. In the latter case, where the thread that is attempting to enter the monitor ends up on the wait queue, it is the thread that currently owns the monitor (and blocks the attempt) whose priority is boosted at step 670. Thus in this case, a thread which already owns the monitor, can have its priority boosted as a new (high priority) thread joins the entry queue. Note however there is no provision for a thread leaving the wait or entry queue, since this cannot occur until the current thread exits the monitor, and the present priority boost ends.

As an example of the processing of FIG. 6 in operation, let us consider 3 threads, T1, T2, and T3, having priority levels P1, P2, and P3 respectively. If we first assume that P1 is medium, P2 is low, and P3 is high, and start from the position of FIG. 5, we find that T2 will have its priority boosted to level P1 (medium), due to the presence of T1 in the wait queue. Now let us assume that T3 tries to enter the monitor 160 to notify T1. This will be unsuccessful given the current ownership by T2. Consequently T3 ends up on the entry queue, and T2 has its priority level further boosted to P3 (high). Note that prior art systems where the mutex provides priority inheritance would provide this second priority boost (to P3), but not the first priority boost. In this situation the first priority boost is helpful because it means that T2 is further advanced by the time that T3 tries to acquire the monitor, so that T2 will release the monitor more quickly, thereby allowing in turn an earlier notification of T1.

If we on the other hand we consider the situation where P3 is low instead of high, then the system of the present invention would first boost T2 to priority P1 as described above, and this would then be unaffected by the addition of T3 to the entry queue. In contrast, prior art systems would not provide any priority boost at all in such circumstances, thereby delaying notification of T1. Finally, if we consider P1 as high, P2 as low, and P3 as medium, then again the system of the present invention would first boost T2 to priority P1 (this time high) as described above, and this would then be unaffected by the addition of T3 to the entry queue. In contrast, prior art systems based solely on mutex priority inheritance would only boost T2 after T3 tried to enter the monitor, and then only to P3 (medium); again the net result would be a delay in the notification of T1.

It will be appreciated that the processing of FIG. 6 is schematic only, and that there are many alternative ways of obtaining an equivalent function. In particular, in some implementations the priority boost associated with the entry queue may be handled separately from the priority boost associated with the wait queue, the former being controlled by the mutex as previously described, the latter by the monitor code.

The embodiment so far discussed has been based on traditional monitors. However, there have also been Java VM implementations which use a bimodal structure for synchronisation; a field in the object itself (a “flat” lock) for situations when there is no contention, and the traditional monitor (“inflated” lock) when there is contention, or when a wait-notify construct is used. The reason for this approach is that the flat lock is much faster than a conventional monitor, but can only store information about a single owning thread. Thus the conventional monitor has to be used if a wait or entry queue is needed. Bimodal locks are described in: “Thin Locks: Featherweight Synchronisation for Java” by Bacon, Konuru, Murthy and Serrano, SIGPLAN '98, Montreal, Canada, p258-268 and “A Study of Locking Objects with Bimodal Fields” by Onodera and Kawachiya, OOPSLA, '99 Conference Proceedings, p223-237, Denver, Colo., USA, November 1999, as well as U.S. patent application Ser. No. 09/574,137, filed May 18, 2000 (IBM docket number GB9-2000-0016), which is hereby incorporated by reference.

The transition between a flat lock and inflated lock (known as “inflation”) occurs when a first thread has ownership of the flat lock, and a second thread tries to acquire ownership. Finding that the lock is already owned, the second thread queues on the object monitor. However, the lock does not become properly inflated until the first thread exits the flat lock. In the current implementation, there is no priority inheritance in this period between the second thread queuing on the object monitor, and the first thread exiting the flat lock. Thus there may be priority inversion, while the second threat waits in the monitor for the first thread to exit the flat lock and the monitor to inflate.

One possibility to overcome this would be for the locking algorithm to take note of the priority of threads being queued for monitor inflation, and boost as necessary the priority of the thread owning the flat lock. Although adding path-length, this would be a useful modification to the locking algorithm in cases where it was important to avoid priority inversion. However a further optimisation is possible by developing the condition variable waiting priority boost approach disclosed herein with the bimodal Java locking mechanism.

Thus the current bimodal Java object locking approach makes use of monitor (condition variable) waits for second and subsequent threads that queue for a monitor lock to be inflated. By allowing a priority boost associated with a condition variable (which is a function of the priority of threads issuing ‘waits’ on the condition variable as described above) then priority inheritance can be provided across bimodal locks. In other words, the priority of those threads waiting on a condition variable can be determined and assigned to an arbitrary thread—in this case the thread owning the flat lock. This priority boost of the first thread (the flat lock owner) would then be reset on flat lock exit. Accordingly, such an approach provides a priority inheritance scheme in a bimodal locking environment.

1. A method of operating a computer system supporting multiple processes having potentially different priorities, said method comprising the steps of:
suspending a first process, pending notification from a second process, wherein said suspending occurs whilst the first process owns a predetermined resource of the computer system subject to mutually exclusive access, and said notification occurs whilst the second process owns said predetermined resource; and
during the suspension of the first process, increasing the priority of a process that acquires ownership of said predetermined resource.

2. The method of claim 1, wherein the priority of said process that acquires ownership of said predetermined resource is increased to a level equivalent to that of said first process.

3. The method of claim 1, further comprising the step of suspending a third process, pending notification from said second process, wherein the priority of said process that acquires ownership of said predetermined resource is increased to a level equivalent to the highest level out of said first and third processes.

4. The method of claim 1, wherein the priority of said process that acquires ownership of said predetermined resource is increased only for the time that it retains ownership of said predetermined resource.

5. The method of claim 1, further comprising the steps of:
providing a queue of any processes waiting to acquire ownership of said predetermined resource; and
increasing the priority of the process that currently has ownership of said predetermined resource to the highest level of any process in the queue.

6. The method of claim 5, wherein the priority of the process that currently has ownership of said predetermined resource is increased to the highest level of any process in the queue, or to the level of said first process, whichever is greater.

7. The method of claim 1, wherein each of said processed comprises a thread.

8. The method of claim 1, wherein said predetermined resource comprises a monitor.

9. A computer program product comprising computer program instructions encoded in a medium in machine readable form, which when loaded into a computer system supporting multiple processes having potentially different priorities cause the system to perform the steps of:
suspending a first process, pending notification from a second process, wherein said suspending occurs whilst the first process owns a predetermined resource of the computer system subject to mutually exclusive access, and said notification occurs whilst the second process owns said predetermined resource; and
during the suspension of the first process, increasing the priority of a process that acquires ownership of said predetermined resource.

10. The computer program product of claim 9, wherein the priority of said process that acquires ownership of said predetermined resource is increased to a level equivalent to that of said first process.

11. The computer program product of claim 9, wherein said computer program instructions further cause the system to perform the step of suspending a third process, pending notification from said second process, wherein the priority of said process that acquires ownership of said predetermined resource is increased to a level equivalent to the highest level out of said first and third processes.

12. The computer program product of claim 9, wherein the priority of said process that acquires ownership of said predetermined resource is increased only for the time that it retains ownership of said predetermined resource.

13. The computer program product of claim 9, wherein said computer program instructions further cause the system to perform the steps of:
providing a queue of any processes waiting to acquire ownership of said predetermined resource; and
increasing the priority of the process that currently has ownership of said predetermined resource to the highest level of any process in the queue.

14. The computer program product of claim 13, wherein the priority of the process that currently has ownership of said predetermined resource is increased to the highest level of any process in the queue, or to the level of said first process, whichever is greater.

15. The computer program product of claim 9, wherein each of said processed comprises a thread.

16. The computer program product of claim 9, wherein said predetermined resource comprises a monitor.

17. A computer system supporting multiple processes having potentially different priorities, said system including:
means for suspending a first process, pending notification from a second process, wherein said suspending occurs whilst the first process owns a predetermined resource of the computer system subject to mutually exclusive access, and said notification occurs whilst the second process owns said predetermined resource; and
means for increasing the priority of a process that acquires ownership of said predetermined resource during the suspension of the first process.

18. The system of claim 17, wherein the priority of said process that acquires ownership of said predetermined resource is increased to a level equivalent to that of said first process.

19. The system of claim 17, further comprising the means for suspending a third process, pending notification from said second process, wherein the priority of said process that acquires ownership of said predetermined resource is increased to a level equivalent to the highest level out of said first and third processes.

20. The system of claim 17, wherein the priority of said process that acquires ownership of said predetermined resource is increased only for the time that it retains ownership of said predetermined resource.

21. The system of claim 17, further comprising:
a queue of any processes waiting to acquire ownership of said predetermined resource; and
means for increasing the priority of the process that currently has ownership of said predetermined resource to the highest level of any process in the queue.

22. The system of claim 21, wherein the priority of the process that currently has ownership of said predetermined resource is increased to the highest level of any process in the queue, or to the level of said first process, whichever is greater.

23. The system of claim 17, wherein each of said processed comprises a thread.

24. The system of claim 17, wherein said predetermined resource comprises a monitor.
